(19) United States
(12) Patent Application Publication
(10) Pub. No.: US 2011/0029987 A1
(43) Pub. Date: Feb. 3, 2011

(54) EMBEDDED ELECTRONIC DEVICE AND COMMUNICATION METHOD THEREOF

(75) Inventors: TENG-YU TSAI, Tu-Cheng (TW); JYH-GWO JU, Tu-Cheng (TW); CHIA-PENG WANG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/617,942

(22) Filed: Nov. 13, 2009

(30) Foreign Application Priority Data
Jul. 29, 2009 (CN) 200910304953.6

(51) Int. Cl. G06F 9/46; G06F 3/048

(52) U.S. Cl. 719/313; 715/804

(57) ABSTRACT

An embedded electronic device includes a system processor, a display module, a first window module and a second window module. The first window module can be run to generate a first window process. The first window module includes a first message definition module to define a target of the message, and a first message transmission module for receiving the message. The second window module can be run by the system processor to display a second window process on a display module. The second window module includes a second message definition module for defining a target of the message and a transmission module for sending the message. The second window process is capable of sending a message to call the first window process. The first window process is capable of receiving and executing the message and returning a result to the second window process.

### BACKGROUND

1. Technical Field

The disclosure generally relates to embedded electronic devices and a communication method between two window processes thereof.

2. Description of Related Art

Embedded electronic devices, such as digital cameras, set-top boxes, digital phone frames, and others provide many functions, such as playing multimedia files, reading documents, and browsing websites.

Multiple windows requiring simultaneous processing by the device are often utilized. Conventional communication between the windows may be difficult. For example, if window B uses a function of window A, window B must include a header file of window A; and if window A is a common object for windows B and C, window A must call the parent window's functions, the window A may include a header files from window B and window C. Redefinition of the function window A, requires that all the header files must be redefined again. Inconvenience is thus incurred to modify the function of the windows in a conventional embedded electronic device.

### BRIEF DESCRIPTION OF THE DRAWINGS

FIG. 1 is a block view of an embedded electronic device according to an embodiment.

FIG. 2 is a block view of two window modules in the electronic device of FIG. 1.

FIG. 3 is a display view of the two window modules of FIG. 2.

FIG. 4 is a flowchart of a communication method between two window processes in an electronic device according to one embodiment.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

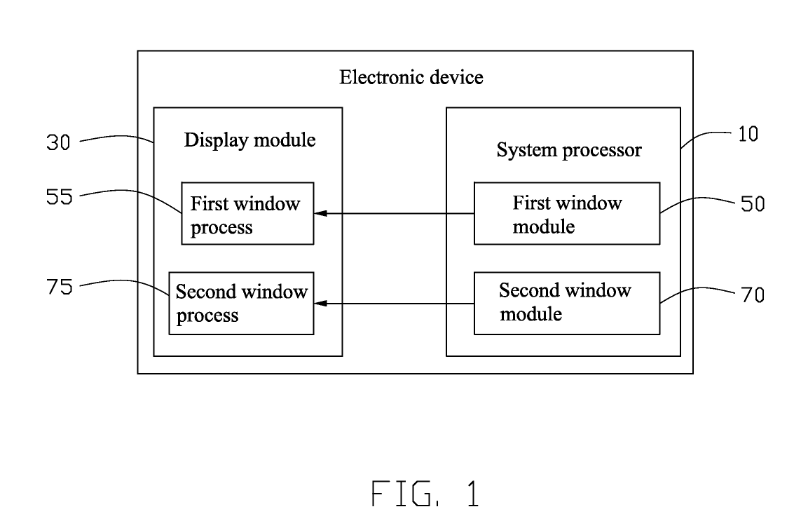

Referring to FIG. 1, an embedded electronic device includes a system processor 10, and a display module 30. The display module 30 is a liquid crystal display. The system processor 10 can run a first window module 50 and a second window module 70. The first window module 50 is a background application module, such as a task management application module, or a volume adjustment application module. The second window module 70 is a foreground application module, such as a multimedia playing application module. When the first window module 50 is executed by the system processor 10, a first window process 55 is created. When the second window module 70 is executed by the system processor 10, a second window process 75 is created and appears on display module 30. A message can be issued to communicate between the first window process 55 and the second window process 75. The message can be a data command or an instruction file.

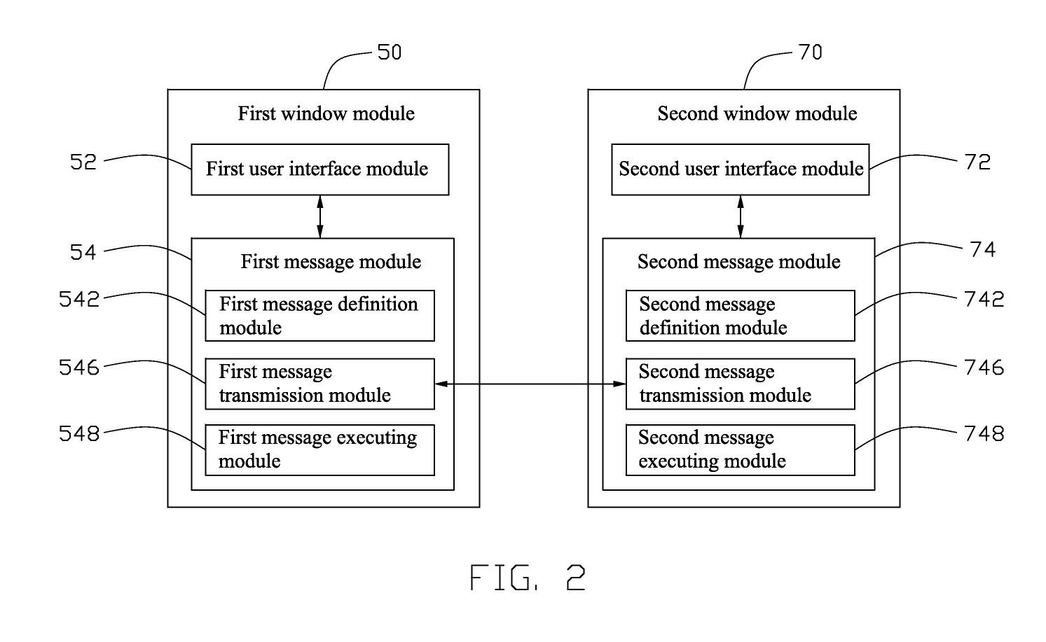

Referring to FIG. 2, the first window module 50 includes a first user interface module 52 and a first message module 54. The first message module 54 further includes a first message definition module 542, a first message transmission module 546 and a first message executing module 548. The second window module 70 includes a second user interface module 72 and a second message module 74. The second message module 54 further includes a second message definition module 742, a second message transmission module 746 and a second message executing module 748. The first message definition module 542 and the second message definition module 742 can define a target of message. The first message transmission module 546 and the second message transmission module 746 can send and receive message.

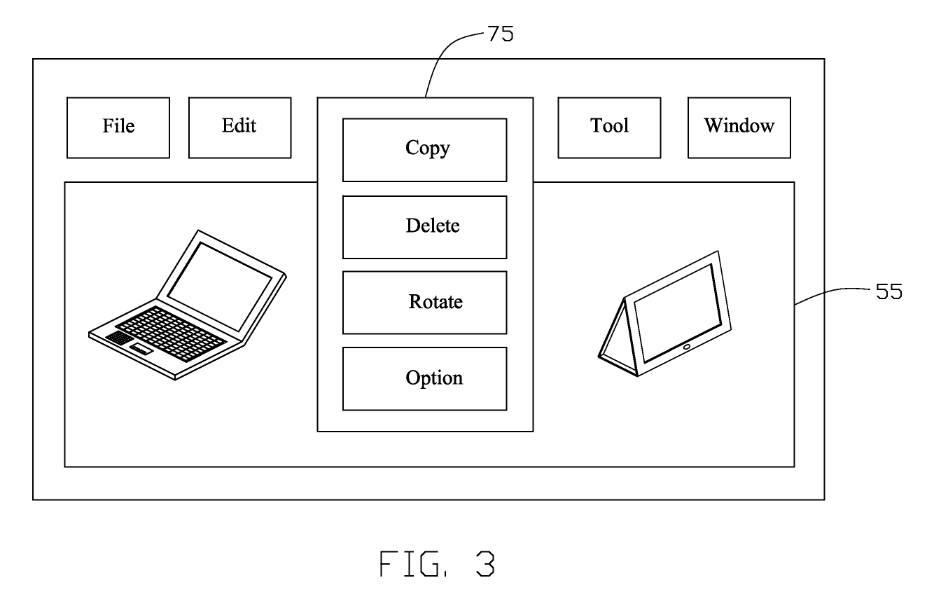

Referring to FIG. 3, when the first window process 55 and the second window process are created, the second window process 75 can be triggered to send the message to call the first window process 55. The first window process 55 can receive and execute the message and return a result to the second window process 75. In one embodiment, the first window process 55 can be displayed on a top layer of the second window process 75 by executing the message. In another embodiment, the second window process 75 can be shut down after the first window process 55 receives the result.

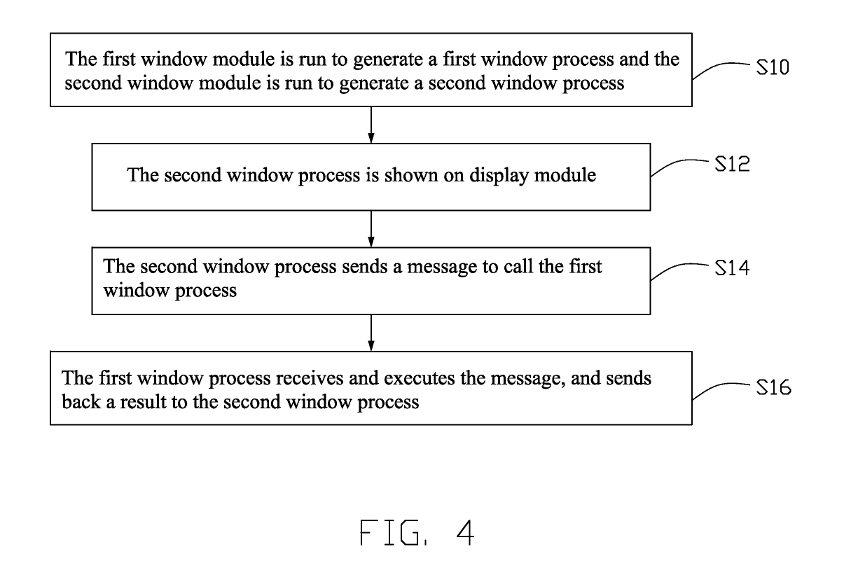

Referring to FIG. 4, a communication method between two window processes in an embedded electronic device according to the embodiment includes the following steps.

In step S10, the first window module 50 is run to generate a first window process 55, and the second window module 70 is run to generate a second window process 75.

In step S12, the second window process 75 is shown on display module 30.

In step S14, the second window process 75 sends a message to call the first window process 55.

In step S16, the first window process 55 receives and executes the message, and returns a result to the second window process 75.

The electronic device employs a message loop system, a message event to trigger functions, such as internet explorer (IE), accordingly, can direct the foreground window process to process something in the background window process, and deliver the message to another window process. This electronic device and the method can provide communication between multiple windows for a of UI project.

It is to be understood, however, that even though numerous characteristics and advantages have been set forth in the foregoing description of preferred embodiments, together with details of the structures and functions of the preferred embodiments, the disclosure is illustrative only, and changes may be made in detail, especially in matters of shape, size, and arrangement of parts within the principles of the disclosure to the full extent indicated by the broad general meaning of the terms in which the appended claims are expressed.

It is also to be understood that the above description and the claims drawn to a method may include some indication in reference to certain steps. However, the indication used is only to be viewed for identification purposes and not as a suggestion as to an order for the steps.

What is claimed is:

1. A method, the method comprising:
running a first window module, to generate a first window process, and a second window module, to generate a second window process;
displaying the second window process on a display module;
sending a message from the second window process to call the first window process; and
receiving and executing the message and returning a result to the second window process by the first window process.

2. The method of claim 1, wherein execution of the message by the first window process further comprises displaying the second window process on a top layer of the first window process.

3. The method of claim 1 further comprising shutting down the second window process after the second window process receives the result.

4. The method of claim 1, wherein display module is a liquid crystal display.

5. The method of claim 1, wherein the second window process is triggered to send a message to call the second window process.

6. The method of claim 1, wherein the message is an instruction file.

7. An embedded electronic device comprising:
a system processor;
a display module;
a first window module capable of being run by the system processor to generate a first window process, the first window module comprising a first message definition module for defining a target of the message, and a first message transmission module for receiving the message; and
a second window module capable of being run by the system processor to generate a second window process, and the second window process capable of being displayed on display module, the second window module comprising a second message definition module for defining a target of the message, and a transmission module for transmitting the message;
wherein the second window process is capable of sending a message to call the first window process, the first window process is capable of receiving and executing the message and returning a result to the second window process.

8. The electronic device of claim 7, wherein the first window process is a background application process.

9. The electronic device of claim 7, wherein the second window process is capable of being shut down after the second window process receives the result.

10. The electronic device of claim 7, wherein the second window process is capable of being triggered to send the message to call the first window process.

11. The electronic device of claim 7, wherein the first window process and the second window process are user interface windows processes.

12. The electronic device of claim 7, wherein the first window process is capable of being displayed on a top layer of the second window process by executing the message.

13. A communication method between two window processes in an embedded electronic device, the method comprising:
providing a system processor; a display module; a first window module capable of being run by the system processor to generate a first window process, the first window module comprising a first message definition module for defining a target of the message, and a first message transmission module for receiving the message; and a second window module capable of being run by the system processor to generate a second window process, and the second window process capable of being displayed on the display module, the second window module comprising a second message definition module for defining a target of the message, and a transmission module for transmitting the message;
running the first window module, to generate the first window process, and the second window module, to generate the second window process;
displaying the second window process on the display module;
sending the message from the second window process to call the first window process; and
receiving and executing the message and returning a result to the second window process by the first window process.
